(19) United States
(12) Patent Application Publication
(10) Pub. No.: US 2025/0334077 A1
(43) Pub. Date: Oct. 30, 2025

(54) SYSTEM AND METHOD FOR PUMP ACCELERATION

(71) Applicant: Hamilton Sundstrand Corporation, Charlotte, NC (US)

(72) Inventor: Ryan Shook, Loves Park, IL (US)

(21) Appl. No.: 18/647,629

(22) Filed: Apr. 26, 2024

(51) Int. Cl. F02C 7/22; F04D 13/02; F23R 3/28

(52) U.S. Cl. CPC F02C 7/22; F01D 15/08; F02C 7/32; F02C 9/30; F23R 3/28

(57) ABSTRACT

A system for accelerating a pump includes a fuel source, a pump, a drive, a turbine, and a combustor. The pump has an inlet in fluid communication with the fuel source and an outlet. The drive is rotationally coupled to the pump and configured to drive the pump to thereby pump fuel from the inlet to the outlet of the pump. The turbine rotationally coupled to the drive and the pump. The combustor fluidly communicates with the outlet of the pump and the inlet of the turbine.

### BACKGROUND

The present disclosure relates generally to fuel systems, and more particularly, to fuel systems with centrifugal pumps.

Combustion engines can be configured to operate primarily within a target speed and/or power range while also operating at higher speeds and/or power outputs from time to time. Supplying fuel to these combustion engines can include a fuel pump optimized for operation within the target speed and/or power range. In certain instances, the fuel pump response may be inadequate when the combustion engine transitions from the target operation speed and/or range to the higher operating speed and/or range. Further features and methods for operating a fuel system are therefore desirable.

### SUMMARY

A system in accordance with an example embodiment of this disclosure includes a fuel source, a pump, a drive, a turbine, and a combustor. The pump includes an inlet in fluid communication with the fuel source and an outlet. The drive is rotationally coupled to the pump and configured to drive the pump to thereby pump fuel from the inlet to the outlet of the pump. The turbine is rotationally coupled to the drive and the pump. The combustor fluidly communicates with the outlet of the pump and an inlet of the turbine.

A method for accelerating the pump in accordance with an example embodiment of this disclosure includes operating a pump with a drive that is rotationally coupled to the pump to drive the pump at an initial rotational speed. The method further includes diverting a portion of fuel discharged at the outlet of the pump into a combustor and combusting the fuel to produce an exhaust stream. The method further includes expanding the exhaust stream across a turbine that is rotationally coupled to the pump to thereby increase the rotational speed of the pump in excess of the initial rotational speed.

### BRIEF DESCRIPTION OF THE DRAWINGS

FIG. 1 is schematic view of an example fuel system with improved transient response.

FIG. 2 is a flow chart describing a method of operating the fuel system of FIG. 1.

### DETAILED DESCRIPTION

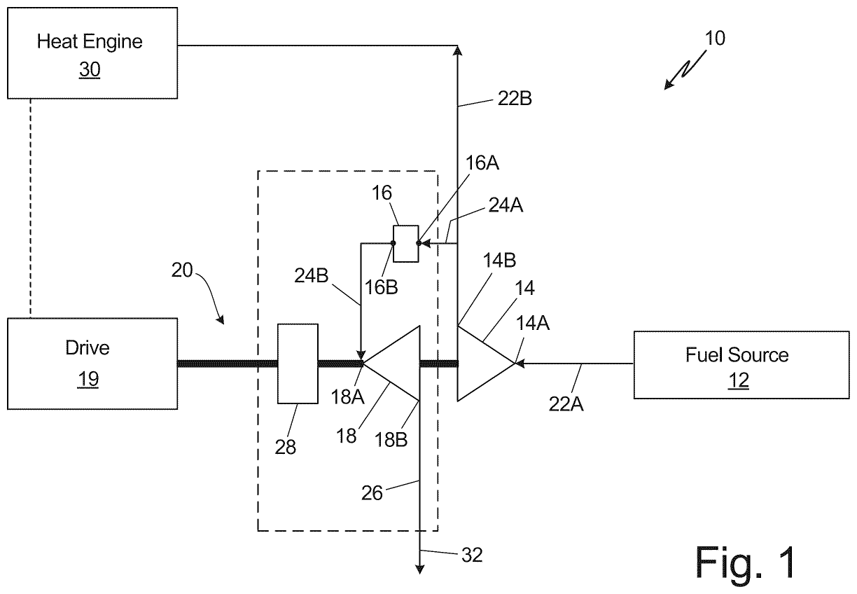

FIG. 1 is a schematic view of an example fuel system that includes components for accelerating a pump in excess of a current rotational speed (e.g., an initial rotational speed). Fuel system 10 includes fuel source 12, pump 14, combustor 16, turbine 18, drive 19, rotational coupler 20, fuel supply lines 22A-22B, branch lines 24A-24B, and discharge line 26. In certain examples, fuel system 10 further includes clutch 28.

Fuel system 10 provides fuel to heat engine 30. In some examples, fuel system 10 is the sole fuel source for operation of heat engine 30. In other examples, fuel system 10 is an auxiliary or secondary fuel system that augments operation of heat engine 30. Fuel system 10 can include additional components other than the components shown with various configurations. Additional components of fuel system 10 can include pumps, valves, lines, and accumulators. Heat engine 30 can be a gas turbine engine, including a turbofan engine, a turboprop engine, a turboshaft engine configured for aircraft propulsion, or a stationary industrial gas turbine engine. Heat engine 30 may operate at one or more operating conditions, each operating condition associated with a different power output and speed of heat engine 30. In some examples, for example a gas turbine engine, heat engine 30 operates primarily at one operating condition, and for shorter durations, at other operating conditions. In the case of gas turbine engines, operating conditions include ground idle, taxiing, take-off power, maximum continuous power, cruise power, and flight idle power, among which, cruise power is the primary operating condition.

Fuel source 12 is any liquid fuel source suitable for heat engine 30. In certain examples, fuel source 12 is a cryogenic fuel source. Cryogenic fuels are liquids with a boiling point below 120.0 Kalvin (−153.15 degrees Celsius). Examples of flammable or combustible cryogenic fuels include, but are not limited to, liquid hydrogen, liquid natural gas (LNG), and liquid methane, among other possible examples.

Pump 14 is fluidly connected to fuel source 12 at inlet 14A and fluidly connected to heat engine 30 at outlet 14B. In operation, pump 14 is configured to increase pressure and flow rate of fuel received at inlet 14A, and to discharge fuel at a target pressure and a target flow rate through outlet 14B. Examples of pump 14 include a centrifugal pump. Pump 14 can be characterized by a pump profile, which relates pressure rise at outlet 14B relative to inlet 14A, rotational speed of pump 14, and input power required to operate pump 14. The performance characteristics of pump 14 are influenced by geometry and other physical characteristics of pump 14 and/or fuel system 10. In many cases, these physical characteristics are selected to minimize input power to pump 14 at a rotational speed of pump 14 corresponding to a primary operating condition of heat engine 30. For example, pump 14 can be optimized for operation at a cruise power condition of a gas turbine engine.

Combustor 16 is a secondary combustor that is discrete from any combustor heat engine 30 adapted to burn an air-fuel mixture in which fuel source 12 provides the fuel and. Inlet 16A to combustor 16 fluidly communicates with outlet 14B of pump 14. Outlet 16B of combustor communicates with inlet 18A of turbine 18. Example combustors 16 include an annular combustor, a can combustor, a can-annular combustor, and a double annular combustor, among other possible combustor configurations.

Turbine 18 can be an axial turbine, a radial turbine, or a mixed flow turbine (i.e., a turbine with axial and radial portions). Inlet 18A of turbine is fluidly connected to outlet 16B of combustor 16. Outlet 18A of turbine 18 is fluidly connected to discharge 32. Discharge 32 can be an exhaust duct communicating with an exterior, ambient environment in some examples. In other examples, discharge 32 can be a combustor, a turbine section, a diffuser section, and/or an exhaust duct of heat engine 30.

Drive 19 provides mechanical and/or electrical motive power to pump 14. Drive 19 can be mechanically coupled to heat engine 30. For gas turbine engine applications, mechanically coupled drives include power take-off shafts and, in some instances, associated gearing (e.g., auxiliary gearbox). The power take-off shaft can be rotationally coupled to a low-pressure shaft, high-pressure shaft, or other working shaft of the gas turbine. Pump 14 can be directly connected to such power take-off shafts. More commonly, gearing between power take-off shafts and pump 14 alters torque, speed, and orientation of pump 14 relative to power take-off shaft. In one example, the power take-off shaft drive gearing of an auxiliary gear box, which is rotationally coupled to pump 14. Electrically driven examples of drive 19 include one or more electric machines (e.g., a motor or a generator), an electrical bus, and, in certain examples, an electrical storage (e.g., a battery system). In one example, drive 19 includes an electric generator mechanically coupled to and driven by heat engine 30 (or another external source), a motor mechanically and rotationally coupled to pump 14, and an electrical bus that connects the electric generator to the motor in order to supply motor with electrical power. In some examples, drive 19 further includes an electrical power storage system (e.g., one or more batteries configured in a series-connected and/or parallel-connected array). Electrical storage system accumulates electrical power produced by the generator before discharging to drive motor and pump 14 via actuation of an electrical switch and/or relay.

Rotational coupler 20 mechanically and rotationally couples drive 19, turbine 18, pump 14, and, in some examples, clutch 28. Examples of rotational coupler 20 can include one or more shafts interconnecting axial adjacent components. For instance, rotational coupler 20 can include a shaft extending between and connecting drive 19 to pump 14 in which turbine 18 can be mounted to the shaft. In another example, rotational coupler 20 can include two shafts in which a first shaft extends between and connects drive 19 to clutch 28 and a second shaft extend between and interconnects clutch 28 to pump 14 with turbine 18 mounted to the second shaft between clutch 28 and pump 14. In other examples, rotational coupler 20 can include more than two shafts, or a different mechanical coupling such as a belt-driven or chain-driven drive, among other possible options.

Fuel supply lines 22A-22B, branch lines 24A-24B, and discharge line 26 can include pipe, conduit, hose, internal component passages, fittings, adapters, or any combination of fluid-connecting components for fluidly connecting components of fuel system 10. Fuel supply lines 22A-22B extend between and fluidly connect fluid source 12 to inlet 14A of pump 14, and between outlet of pump 14 and heat engine 30, respectively. Branch line 24A fluidly connects fuel supply line 22B to inlet 16A of combustor 16 at a location downstream from outlet 14B of pump 14. Branch line 22B fluidly connects outlet 16B of combustor 16 to inlet 18A of turbine 18. Discharge line 26 extends between and fluidly connects outlet 18B of turbine 18 to discharge 32.

Clutch 28 includes a coupled state and an uncoupled state. In the coupled state, drive 19 is rotationally connected to turbine 18 and pump 14. In the uncoupled state, drive 19 is rotationally disconnected from turbine 18 and pump 14. In some examples, clutch 28 is a directional clutch (e.g., a sprag clutch, an overrunning clutch). Directional clutches are configured to automatically transition into an uncoupled state without intervention from a controller or other operator input. In some examples, clutch 28 automatically transitions into an uncoupled state when a rotational speed of turbine 18 and pump 14 exceeds a rotational speed of drive 19. Further, clutch 28 automatically transitions into a coupled statue when a rotational speed of drive 19 equals or exceeds a rotational speed of turbine 18 and pump 14. In another example, clutch 28 can be engaged or disengaged in response to a signal received from a controller. In either example, clutch 28 enables turbine 18, via expansion of exhaust flow from combustor 16, to increase a rotational speed of turbine 18 and pump 14 above a rotational speed of drive 19 during a transient operating condition of heat engine 30 when drive 19, due to physical and/or electrical limitations of a connection to heat drive 19, is otherwise not able to meet that rate of acceleration demand on pump 14.

In operation, fuel system 10 provides fuel from fuel source 12 to heat engine 30 using pump 14, which is optimized to operate at a primary operating condition of heat engine 30. Periodically, additional fuel diverts from supply line 22B into combustor 16 and ignited, creating an exhaust flow. Turbine 18 extracts work from the exhaust flow to rotationally accelerate pump 14. The exhaust flow exits system 10 at discharge 32. Clutch 28, when present, permits pump 14 to disconnect automatically from drive 19 during acceleration exceeding a rotational speed of drive 19. In certain operation conditions, drive 19 increases rotational speed until clutch 28 reengages drive 19 to turbine 18 and pump 14. In other operation conditions, fuel ceases to divert into combustor 16 and a rotational speed of pump 14 and turbine 18 decreases until clutch reengages.

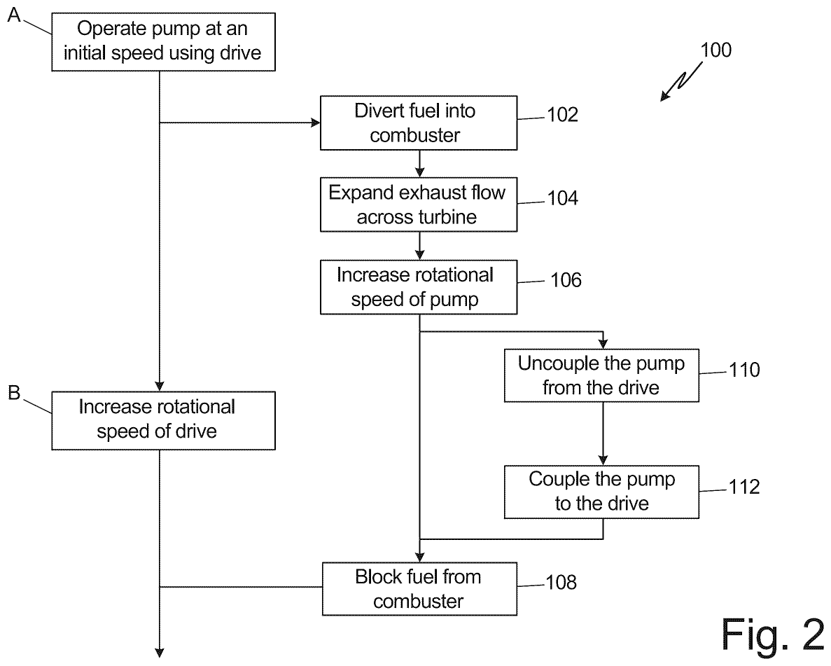

FIG. 2 is a flow chart describing a method for operating system 10. Method 100 includes steps 102, 104, 106, and 108. In some examples, method 100 additionally includes steps 110 and 112. The sequence depicted is for illustrative purposes only and is not meant to limit the method 100 in any way as it is understood that the portions of the method can proceed in a different logical order, additional or intervening portions can be included, or described portions of the method can be divided into multiple portions, or described portions of the method can be omitted without detracting from the described above.

In operation, drive 19 rotates turbine 18 and pump 14 at an initial rotational speed. The rotational speed of pump 14 can increase or decrease with a rotational speed of drive 19. However, in certain applications, the rotational speed of drive 19 may be mechanically-coupled or electrically-coupled to heat engine 30 or otherwise unable to increase fuel to heat engine 30 via pump 14 at a sufficient rate. In these circumstances, method 100 can enable pump 14 to provide a faster response, delivering fuel at a higher rate than is otherwise possible with drive 19.

In step 102, a portion of fuel is diverted from supply line 22B into combustor 16. That is to say, less than all of the fuel flowing through supply line 22B diverts into combustor 16. Since supply line 22B communicates with a discharge or outlet of pump 14, fuel enters combustor via one or more injectors at a target fuel pressure and fuel flow rate. For example, fuel can be diverted by a three-way valve that includes at least three positions. In a first position, branch line 24A is blocked while supply line 22B is open to heat engine. In a second position, a portion of fuel from supply line 22B diverts to branch line 24A and, hence, into combustor 16. Within combustor 16, the diverted fuel mixes with air and the air-fuel mixture ignites, generating an exhaust flow into branch line 24B.

In step 104, the exhaust flow enters turbine 18, imparting work to turbine 18. A rotational speed of turbine 18 increases and hence a rotational speed of pump 14 increases in step 106. In step 108, fuel is blocked from entering combustor 16 by, for example, actuation of the three-way valve.

In some examples of method 100, clutch 28 transitions to the uncoupled state in response to the rotational speed of turbine 18 and pump 14 exceeding a rotational speed of drive 19 in step 110. In step 112, clutch transition to the coupled statue in response to a rotational speed of drive 19 increases to an equal or greater than a rotational speed of turbine 18 and pump 14. In other examples, clutch 28 transitions to the coupled state in response to a rotational speed of turbine 18 and pump 14 decreasing to be equal to or less than the rotational speed of drive 19.

### Discussion of Possible Embodiments

The following are non-exclusive descriptions of possible embodiments of the present invention.

### A System for Accelerating a Pump

A system according to an example embodiment of this disclosure includes, among other possible things, a fuel source, a pump, a drive, a turbine, and a combustor. The pump includes an inlet in fluid communication with the fuel source and an outlet. The drive is rotationally coupled to the pump and configured to drive the pump to thereby pump fuel from the inlet to the outlet of the pump. The turbine is rotationally coupled to the drive. The combustor is in fluid communication with the outlet of the pump and an inlet of the turbine.

The system of the preceding paragraph can optionally include, additionally and/or alternatively, any one or more of the following features, configurations and/or additional components.

A further embodiment of the foregoing system can further include a shaft rotationally coupled to the pump drive, the turbine, and the pump.

A further embodiment of any of the foregoing systems, wherein the drive can be mechanically coupled to a combustion engine.

A further embodiment of any of the foregoing systems, wherein operation of the combustion engine can impart work to the pump.

A further embodiment of any of the foregoing systems, wherein the drive can be electrically coupled to an electric machine.

A further embodiment of any of the foregoing systems, wherein the electric machine cab supply electric power to the drive for imparting work to the pump.

A further embodiment of any of the foregoing systems can further include a clutch.

A further embodiment of any of the foregoing systems, wherein the clutch can have a coupled state in which the drive is rotational coupled to the turbine and the pump.

A further embodiment of any of the foregoing systems, wherein the clutch can have an uncoupled state in which the drive is rotationally uncoupled from the turbine and the pump.

A further embodiment of any of the foregoing systems, wherein the clutch can be a directional clutch.

A further embodiment of any of the foregoing systems, wherein the clutch can transition to the uncoupled state in response a rotational speed of the turbine and the pump exceeding a rotational speed of the drive.

A further embodiment of any of the foregoing systems, wherein the clutch can transition to the coupled state in response to the rotation speed of the drive equaling or exceeding the rotational speed of the turbine and the pump.

A further embodiment of any of the foregoing systems, wherein the fuel source can contain a cryogenic fluid.

A further embodiment of any of the foregoing systems, wherein the fuel source can store liquid hydrogen.

### A Method for Accelerating a Pump

A method of accelerating a pump having an inlet in fluid communication with a fuel source and an outlet according to an example embodiment of this disclosure includes, among other possible things, operating the pump with a drive that is rotationally coupled to the pump, wherein the drive operates the pump at an initial rotational speed. The method further includes diverting a portion of fuel discharged at the outlet of the pump into a combustor and combusting the fuel to produce an exhaust stream. The method further includes expanding the exhaust stream across a turbine that is rotationally coupled to the pump to thereby increase the rotational speed of the pump in excess of the initial rotational speed.

The method of the preceding paragraph can optionally include, additionally and/or alternatively, any one or more of the following steps, features, configurations and/or additional components.

A further embodiment of the foregoing method can include uncoupling, using a clutch, the pump and the turbine from the drive in response to the rotational speed of the pump exceeding the initial rotational speed.

A further embodiment of any of the foregoing methods can include coupling, using the clutch, the pump and the turbine to the drive in response to a rotational speed of the drive equaling or exceeding the rotational speed of the pump.

A further embodiment of any of the foregoing methods, wherein the clutch can be a directional clutch.

A further embodiment of any of the foregoing methods, wherein uncoupling and recoupling the turbine and the pump to the drive can occur passively in response to a difference between the rotational speed of the turbine and the pump and the rotational speed of the drive.

A further embodiment of any of the foregoing methods, wherein operating the drive can include using a heat engine to mechanically rotate the drive.

A further embodiment of any of the foregoing methods, wherein operating the drive can include using a generator to electrically rotate the drive.

A further embodiment of any of the foregoing methods, wherein the pump can have a power profile indicative of power required to operate the pump as a function of the rotational speed of the pump.

A further embodiment of any of the foregoing methods, wherein the power profile can include a minimum power operating point coinciding with the initial rotational speed.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system comprising:
a fuel source;
a pump having an inlet in fluid communication with the fuel source and an outlet;
a heat engine fluidly connected to the outlet of the pump by a fuel supply line;
a drive rotationally coupled to the pump and configured to drive the pump and thereby pump fuel from the inlet to the outlet of the pump, wherein the drive is coupled to and driven by the heat engine;
a turbine rotationally coupled to the drive;
a combustor disposed along a branch line of the fuel supply line, the combustor is in fluid communication with the outlet of the pump and an inlet of the turbine, wherein the turbine and the combustor are separate from the heat engine; and
a clutch having a coupled state in which the drive is rotationally coupled to the turbine and the pump, and an uncoupled state in which the drive and the heat engine are rotationally uncoupled from the turbine and the pump;
wherein the clutch is a directional clutch, and wherein the clutch transitions to the uncoupled state in response to a rotational speed of the turbine and the pump exceeding a rotational speed of the drive.

2. The system of claim 1, further comprising:
a shaft rotationally coupled to the drive, the turbine, and the pump.

3. The system of claim 1, wherein the drive is mechanically coupled to the heat engine, and wherein operation of the heat engine imparts work to the pump.

4. The system of claim 1, wherein the drive is electrically coupled to an electric machine, and wherein the electric machine supplies electric power to the drive for imparting work to the pump.

5. (canceled)

6. (canceled)

7. The system of claim 1, wherein the clutch transitions to the coupled state in response to the rotation speed of the drive equaling or exceeding the rotational speed of the turbine and the pump.

8. The system of claim 7, wherein the fuel source is a cryogenic fluid.

9. The system of claim 8, wherein the fuel source is liquid hydrogen.

10. A method of accelerating a pump having an inlet in fluid communication with a fuel source and an outlet, the method comprising:
operating the pump with a drive that is rotationally coupled to the pump, wherein the drive operates the pump at an initial rotational speed to supply fuel from a fuel source to a heat engine along a fuel supply line, wherein the drive is coupled to and driven by the heat engine;
diverting a portion of fuel discharged at the outlet of the pump along a branch line into a combustor, wherein the branch line is fluidly connected to the outlet of the pump via the fuel supply line;
combusting the fuel to produce an exhaust stream; and
expanding the exhaust stream across a turbine that is rotationally coupled to the pump to thereby increase the rotational speed of the pump in excess of the initial rotational speed, wherein the turbine and the combustor are separate from the heat engine; and
uncoupling, using a directional clutch, the pump and the turbine from the drive and the heat engine in response to the rotational speed of the pump exceeding the initial rotational speed, wherein uncoupling and recoupling the turbine and the pump to the drive occurs passively in response to a difference between the rotational speed of the turbine and the pump and the rotational speed of the drive.

11. (canceled)

12. The method of claim 10, further comprising:
coupling, using the clutch, the pump and the turbine to the drive in response to a rotational speed of the drive equaling or exceeding the rotational speed of the pump.

13. (canceled)

14. (canceled)

15. The method of claim 10, wherein operating the drive includes using the heat engine to mechanically rotate the drive.

16. The method of claim 10, wherein operating the drive includes using a generator to electrically rotate the drive.

17. The method of claim 10, wherein the pump has a power profile indicative of power required to operate the pump as a function of the rotational speed of the pump, and wherein the power profile includes a minimum power operating point coinciding with the initial rotational speed.

18. A system comprising:
a fuel source;
a pump having an inlet in fluid communication with the fuel source and an outlet;
a gas turbine engine fluidly connected to the outlet of the pump by a fuel supply line;
a drive and a turbine, each rotationally coupled to the drive by a shaft, wherein the drive is coupled to and driven by the gas turbine engine;
a combustor disposed along a branch line of the fuel supply line, the combustor is in fluid communication with the outlet of the pump and an inlet of the turbine, wherein the turbine and the combustor are separate from the gas turbine engine; and
a clutch having a coupled state in which the drive is rotationally coupled to the turbine and the pump, and an uncoupled state in which the drive and the gas turbine engine are rotationally uncoupled from the turbine and the pump;
wherein, in the coupled state, the pump is rotationally driven by the gas turbine engine via the drive; and
wherein, in the uncoupled state, the pump is rotationally driven by an exhaust flow produced by the combustor and expanded across the turbine, and
wherein the clutch is a directional clutch, and wherein the clutch transitions to the uncoupled state in response to a rotational speed of the turbine and the pump exceeding a rotational speed of the drive.

19. (canceled)

20. The system of claim 18, wherein the clutch transitions to the coupled state in response to the rotation speed of the drive equaling or exceeding the rotational speed of the turbine and the pump.

21. The system of claim 18, wherein the drive is mechanically coupled to the gas turbine engine by a power take-off shaft.

22. The system of claim 18, wherein the drive includes a motor that is electrically coupled to an electric machine driven by the gas turbine engine and an energy storage via an electrical bus.
